(19) United States
(12) Patent Application Publication
(10) Pub. No.: US 2009/0126547 A1
(43) Pub. Date: May 21, 2009

(54) CUTTING UNIT

(76) Inventor: Bernd LOIBL, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 12/356,993

(22) Filed: Jan. 21, 2009

Related U.S. Application Data
(62) Division of application No. 11/702,586, filed on Feb. 6, 2007.
Application No. 11/702,586 is a continuation of application No. 11/185,886, filed on Jul. 21, 2005, now abandoned.

(30) Foreign Application Priority Data
Mar. 23, 2005 (DE) 20 2005 004 916.6

(51) Int. Cl. B26D 1/00; B26D 7/00

(52) U.S. Cl. 83/614; 83/651; 83/597; 83/856

(57) ABSTRACT

A cutting unit (1, 11, 41) for trimming sheet material has a support plate (3, 13, 43) for supporting the sheet material (56) to be trimmed. At least one cutting device (4, 14, 15, 44, 59) is associated with the support plate (3, 13, 43). At least one storage compartment (10, 33, 53) is provided beneath the support plate (3, 13, 43) with a horizontal spacing from the at least one cutting device (4, 14, 15, 44, 59).

### CROSS-REFERENCE TO RELATED APPLICATIONS AND CLAIM TO PRIORITY

This application is based upon utility model application number 20 2005 004 916.6, filed Mar. 23, 2005 in the Federal Republic of Germany, the disclosure of which is incorporated herein by reference and to which priority is claimed.

### FIELD OF THE INVENTION

The invention concerns a cutting unit for trimming sheet material such as paper or films, having a support plate for supporting the sheet material during the cutting operation, and having at least one cutting device associated with the support plate.

### BACKGROUND OF THE INVENTION

Cutting units of the aforesaid kind are intended in particular for office purposes. They are used to trim sheet material such as paper, films, or photographs. Such cutting units as a rule comprise a support plate on which the sheet material to be trimmed is placed for the cutting operation, and a cutting device, usually in the form of a guillotine cutting device, arranged on the edge of the support plate. To allow photographs to be trimmed more accurately, cutting units have also been developed that have two cutting devices on either side of the support plate, specifically a guillotine cutting device and a rotary cutting device (cf. DE 20 307 241 U and DE 20 319 003 U).

Before or after a cutting operation, there is often a need for additional office items or for storage thereof, for example a staple remover for removing staples from stacks of pages, for storage of paper clips for a stapler in order to staple pages together, or for writing instruments in order to write on them. If they are not present, they must be retrieved from appropriate locations. Apparatuses for storage in the vicinity of the cutting unit are especially necessary, or the items will be lying around loose.

### SUMMARY OF THE INVENTION

It is the object of the invention to make provisions so that additional office items can be accommodated in the region of a cutting unit, in orderly fashion and without an additional space requirement.

This object is achieved, according to the present invention, in that at least one storage compartment is provided beneath the support plate and with a horizontal spacing from the cutting device or devices. The basic idea of the invention is therefore to use as a storage compartment the space beneath the support plate hitherto unused in cutting units. Office accessories such as staple removers, staplers, or the like, but also other office items such as staples, writing instruments, or the like can be housed in this storage compartment without an additional space requirement. The cutting unit according to the present invention therefore creates the preconditions allowing the operations arising before or after a cutting operation to be performed contemporaneously and without delay, and the space around the cutting unit to remain clear for actual office work.

In an embodiment of the invention, provision is made for the storage compartment to be openable by the fact that the support plate is at least partly removable from the region of the storage compartment, for example by at least partially swinging it up or displacing it laterally.

According to a further feature of the invention, provision is made for at least one storage compartment, or a portion thereof, to be sealed in airtight fashion. This can be accomplished, for example, in that the storage compartment contains or comprises an airtight but openable box. The airtight nature means that objects sensitive to atmospheric influences, for example photographic papers, can be accommodated in the storage compartment or in the airtight portion.

The invention furthermore provides for the storage compartment to be subdivided into sub-compartments in order to store different objects separately from one another. It is further proposed that the support plate be at least locally transparent in the region of the storage compartment. As a result, it is possible to determine at a glance whether the desired office item is actually present in the storage compartment.

The size of the storage compartment should make the best possible use of the space beneath the support plate. It is therefore recommended to use at least 50% of the area of the support plate for the storage compartment located therebeneath, since the space beneath the support plate is usually empty, and the space for the reception of office items might not be large enough. In particular, the storage compartment should also be large enough to accommodate sheet material, such as paper or the like, for the trimming of which the respective at least one cutting device is designed in terms of size.

The cutting unit according to the present invention can comprise a cutting device that is embodied as a guillotine cutting device, the guillotine cutting device comprising a pivotably mounted knife arm having a blade held thereon and a counterknife held in stationary fashion on the bed. Alternatively, the cutting device can also be embodied as a rotary cutting device that has a knife carriage displaceable on a guide bar and a circular knife rotatably mounted on that carriage. In a particularly preferred embodiment, however, both alternatives can also be combined with one another on one cutting unit, for example in such a way that the guillotine cutting device is arranged on one side of the bed and the rotary cutting device on the other side of the bed, preferably so that the cutting devices extend parallel to one another.

According to a further feature of the invention, provision is made for there to be provided, between the guillotine cutting device and rotary cutting device, a stop bar that extends parallel to the cutting devices and is displaceably guided transversely to the cutting devices.

In a further, preferred embodiment, the guillotine cutting device is embodied to be replaceable with the rotary cutting device and vice versa, so that one or the other cutting device can be fitted to the bed depending on the type of sheet material to be trimmed. For that purpose, the bed on the one hand, and the guillotine cutting device and rotary cutting device on the other hand, can comprise complementary retaining elements with which either the guillotine cutting device or the rotary cutting device can be attached to one side of the bed. The retaining elements can comprise latch devices which are embodied in such a way that they are self-latching upon attachment of the guillotine cutting device or rotary cutting device, but require a release actuation of the latch device upon removal.

### DESCRIPTION OF THE DRAWINGS

The invention is illustrated in more detail, with reference to two exemplifying embodiments, in the drawings, in which:

FIG. 1 is a perspective view of a first cutting unit having a guillotine cutting device, with the storage compartment closed;

FIG. 2 is a perspective view of the cutting unit of FIG. 1 with the storage compartment open;

FIG. 3 is a perspective view of a second cutting unit having two cutting devices;

FIG. 4 is a plan view of the cutting unit shown in FIG. 3;

FIG. 5 is a perspective view of a third cutting unit having a rotary cutting device, with the storage compartment closed;

FIG. 6 is a view of the third cutting unit as shown in FIG. 5 with the storage compartment open;

FIG. 7 is a perspective view of the cutting unit shown in FIGS. 4 and 5, with the rotary cutting unit removed and with an associated guillotine cutting device.

### DETAILED DESCRIPTION OF THE PREFERRED EMBODIMENTS

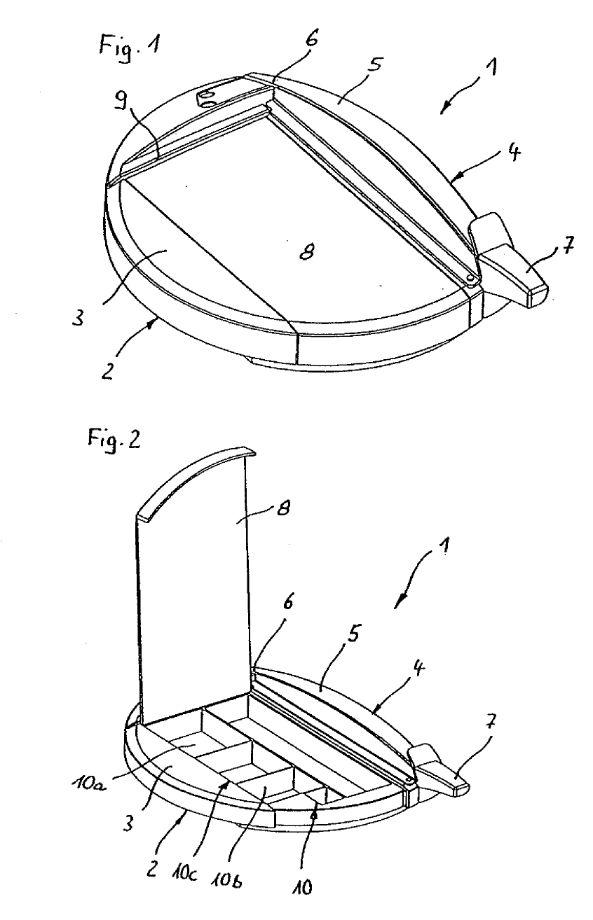

Cutting unit 1 depicted in FIGS. 1 and 2 comprises a frame plate 2, forming a substantially semicircular outline, whose horizontal upper side forms a support plate 3 for sheet material to be trimmed. A guillotine cutting device 4 is located on the straight side of frame plate 2.

Guillotine cutting device 4 comprises a knife arm 5 that is mounted pivotably, in a bearing 6, about a horizontal axis extending transversely to the longitudinal side there.

Knife arm 5 is equipped on its lower side, substantially over its entire length, with a cutting knife that is concealed in this view. Configured at the free end of knife arm 5 is a handle 7 with which knife arm 5 can be pivoted upward and downward about bearing 6. In the position shown, knife arm 5 is located in the lower terminal position.

The larger portion of support plate 3 is separated from the remaining portion, and forms a cover plate 8. It is mounted upwardly pivotably on one side via a hinge 9, and can therefore be pivoted out of the closed position depicted in FIG. 1 into an approximately vertical position, as shown in FIG. 2. Located beneath cover plate 8 is a storage compartment 10, visible in FIG. 2, which is embodied as a storage tray that constitutes a bottom 10a on the lower side, is open at the top, and is hooked into frame plate 2. The storage tray is subdivided by vertical ribs (labeled 10b by way of example) in such a way that storage compartment 10 comprises multiple sub-compartments (labeled 10c by way of example) separated from one another. Office items or small office accessories can then be accommodated in these sub-compartments 10c.

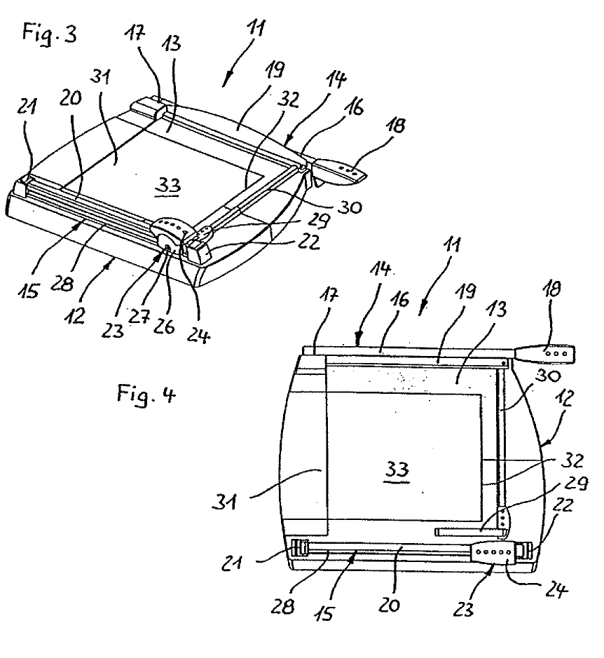

Cutting unit 11 depicted in FIGS. 3 and 4 comprises a frame plate 12, forming a substantially rectangular outline, whose horizontal upper side constitutes a support plate 13 for the support of sheet material to be trimmed. A guillotine cutting device 14 is arranged on the upper (in both views) longitudinal side, and a rotary cutting device 15 on the lower (in the views) longitudinal side. The two cutting devices 14, 15 extend parallel to one another.

Guillotine cutting device 14 comprises a knife arm 16 that is mounted pivotably, in a bearing 17, about a horizontal axis extending transversely to the longitudinal side there. Knife arm 16 is equipped on its lower side, substantially over its entire length, with a cutting knife that is concealed in these views. Configured at the free end of knife arm 16 is a handle 18 with which knife arm 16 can be pivoted upward and downward. In the position shown, knife arm 16 is located in the lower terminal position.

The cutting knife of knife arm 16 corresponds to a counterknife that is recessed flush into frame plate 2. Joined to knife arm 16 is a protective apparatus 19 that covers the cutting knife when knife arm 16 is lowered, and thus offers protection for the operator.

Rotary cutting device 15 comprises a guide bar 20 that extends at a distance from support plate 13, parallel to the cutting edge and cutting direction of guillotine cutting device 14, between two holding blocks 21, 22. A knife carriage 23 is guided on guide bar 20 displaceably in the direction of the longitudinal axis of guide bar 20. It can be slid manually back and forth using handle 24.

A circular knife, covered by a protective cap 26, is mounted rotatably on knife carriage 23. Mounting is accomplished about a horizontal axis 27 that extends transversely to the longitudinal axis of guide bar 20. The circular knife projects downward beyond knife carriage 23 and makes contact against a counterknife bar 28 that is recessed into support plate 13 and extends parallel to guide bar 20.

Extending between guillotine cutting device 14 and rotary cutting device 15, parallel to them, is a stop bar 29 against which sheet material can be aligned. Stop bar 29 encompasses at the end a guide bar 30, and is guided thereon in transversely displaceable fashion. Guide bar 30 extends at right angles to the cutting directions of guillotine cutting device 14 and rotary cutting device 15.

A portion of support plate 13 is separated from the remaining portion thereof, and forms a cover plate 31. Cover plate 31 is joined to the remaining portion of support plate 13 via a hinge 32, and can be swung upward about that hinge 32. Located beneath cover plate 31 is a storage compartment 33 that is embodied in the shape of a tray and is delimited on the lower side by a bottom. Storage compartment 33 is open at the top and is closed off only by cover plate 31. The latter is of transparent configuration, so that the contents of storage compartment 33 are recognizable from outside.

Storage compartment 33 is sufficiently large that paper can also be placed into storage compartment 33. The possibility moreover exists of setting into storage compartment 33 an airtight box, and placing therein, in protected fashion, objects (such as photographic papers) that are sensitive to atmospheric influences. A peripheral seal, with which an airtight closure can be achieved, can instead be provided between cover plate 31 and frame plate 2.

Cutting unit 41 depicted in FIGS. 5 through 7 comprises, like cutting unit 11, a frame plate 42, forming a substantially rectangular outline, whose horizontal upper side forms a support plate 43 for the support of sheet material to be trimmed.

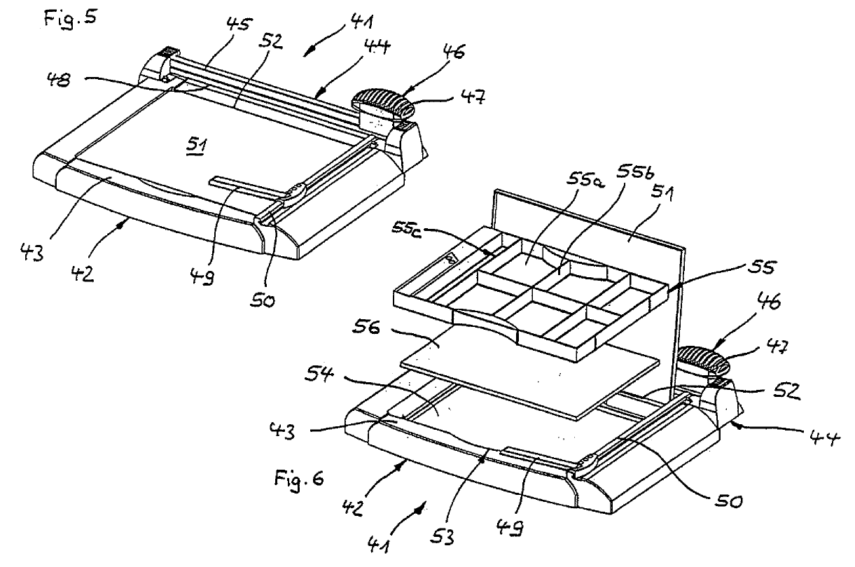

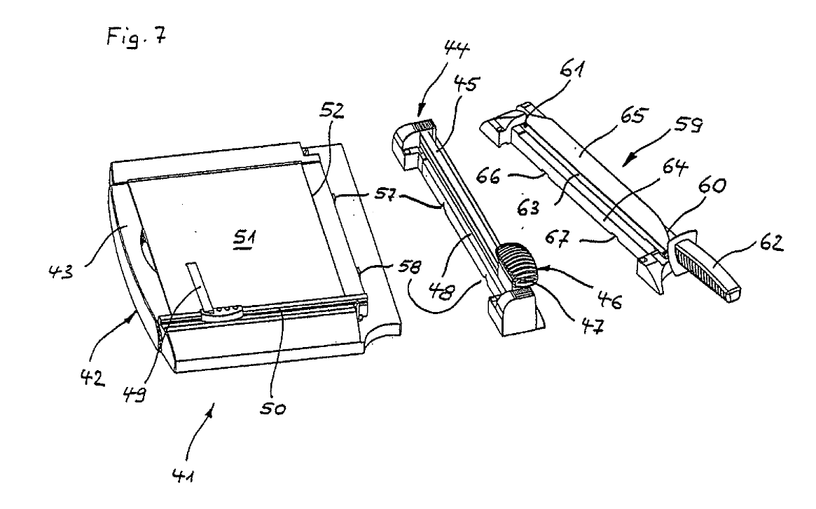

As is evident from FIGS. 5 and 6, a rotary cutting device 44 is attached on the upper longitudinal side. It comprises a guide bar 45 on which a knife carriage 46 is displaceably guided. The latter can be slid manually back and forth along guide bar 45 using handle 47.

A circular knife (here concealed) is mounted rotatably on knife carriage 46. Mounting is accomplished about a horizontal axis that extends transversely to the longitudinal axis of guide bar 45. The circular knife projects downward beyond knife carriage 46 and makes contact against a counterknife bar 48 that is recessed into support plate 43 and extends parallel to guide bar 45.

Extending parallel to the longitudinal axis of guide bar 45 is a stop bar 49 against which sheet material can be aligned. Stop bar 49 encompasses at the end a guide bar 50, and is guided thereon in transversely displaceable fashion. Guide bar 50 extends at right angles to rotary cutting device 44.

A portion of support plate 43 is separated from the remaining portion thereof, and forms a cover plate 51. Cover plate 51 is joined to the remaining portion of support plate 43 via a hinge 52, and can be swung upward about that hinge 52 out of the closed position in FIG. 5 into an approximately vertical position, as visible in FIG. 6. Located beneath cover plate 51 is a storage compartment 53 that is closed off on the lower side by a bottom 54. A storage tray 55 having a bottom 55a on the lower side is set into storage compartment 53. Storage tray 55 is open at the top and is subdivided by vertical ribs (labeled 55b by way of example) into multiple sub-compartments (labeled 55c by way of example) separated from one another. Office items or small office accessories can then be accommodated in these sub-compartments 55c.

Located below storage tray 55, depicted in the raised state, is an open space into which sheet material can be placed, for example photographic paper. The base outline of storage compartment 53 is dimensioned so that, for example, DIN A4 sheet material can be placed in it without having to be folded.

As is evident from FIG. 7, rotary cutting device 44 can be removed completely from frame plate 52. Provided for that purpose on frame plate 42 and on rotary cutting device 44 are complementary latch devices 57, 58 that latch to one another when inserted into one another. Rotary cutting device 44 can be removed by unlatching.

Removal of rotary cutting device 44 makes it possible to replace it with guillotine cutting device 59, likewise depicted in FIG. 7. Guillotine cutting device 59 comprises a knife arm 60 that is mounted pivotably, in a bearing 61, about a horizontal axis extending transversely to the longitudinal axis of knife arm 60. Knife arm 60 is equipped on its lower side, substantially over its entire length, with a cutting knife that is concealed in this view. Configured at the free end of knife arm 60 is a handle 62 with which knife arm 60 can be pivoted upward and downward. In the position shown, knife arm 60 is located in the lower terminal position.

The cutting knife of knife arm 60 corresponds to a counterknife 61 that is secured to a frame portion 62. Joined to knife arm 60 is a protective apparatus 63 that covers the cutting knife and thus offers protection for the operator.

Frame portion 62, like rotary cutting device 44, comprises latch devices 64, 65 complementary to latch devices 57, 58. Guillotine cutting device 59 can be joined to frame plate 42 by way of these latch devices 64, 65, so that sheet material for which a guillotine cutting device 59 is more suitable than a rotary cutting device 44 can then be cut with cutting unit 41.

1-16. (canceled)

17. A cutting unit for trimming sheet material, comprising:
a frame having opposite side portions with upper surfaces situated in a first plane, and a central portion situated between the opposite side portions, the central portion having an upper surface situated in a second plane that is recessed from the first plane to define the bottom of a storage compartment;
a cover plate movably secured to the frame and movable between a closed position in which the cover plate defines a top of the storage compartment and an upper surface of the cover plate is coplanar with the first plane, and an open position in which the storage compartment is accessible, the cover plate in the closed position and the side portions collectively establishing a support surface for supporting sheet material to be trimmed;
at least one cutting device securable to the frame; and
a storage tray receivable in the storage compartment when the cover plate is in the closed position, and removable from the storage compartment when the cover plate is in the open position, wherein when the storage tray is received in the storage compartment the storage tray is spaced above the recessed upper surface of the central portion to define a lower storage space.

18. The cutting unit of claim 17, further comprising a hinge pivotally connecting the cover plate to the frame.

19. The cutting unit of claim 17, wherein the lower storage space is dimensioned to receive DIN A4 sheet material.

20. The cutting unit of claim 17, wherein the storage tray is open at the top comprises vertical ribs that subdivide a storage area of the storage tray into multiple sub-compartments.

21. The cutting unit of claim 17, wherein the upper surface of the central portion is parallel to the first plane.

22. The cutting unit of claim 17, wherein the frame further comprises a ledge located in the storage compartment, the storage tray resting on the ledge when the storage tray is received in the storage compartment to maintain the storage tray spaced above the recessed upper surface of the central portion to define the lower storage space.

23. The cutting unit of claim 17, wherein the storage compartment is sealed in airtight fashion when the cover plate is in the closed position.

24. The cutting unit of claim 17, wherein the support surface is locally transparent at least above the storage compartment.

25. The cutting unit of claim 17, wherein the cutting device comprises a guillotine cutting device comprising a pivotally mounted knife arm having a blade.

26. The cutting unit of claim 25, further comprising a stationary counter-knife.

27. The cutting unit of claim 17, wherein the cutting device comprises a rotary cutting device comprising a knife carriage displaceable on a guide bar and a circular knife rotatably mounted on the knife carriage.

28. The cutting unit of claim 27, further comprising a guillotine cutting device comprising a pivotally mounted knife arm having a blade.
